(19) United States
(12) Patent Application Publication
(10) Pub. No.: US 2014/0022400 A1
(43) Pub. Date: Jan. 23, 2014

(54) IP CAMERA CONTROL METHOD

(71) Applicant: HON HAI PRECISION INDUSTRY CO., LTD., New Taipei (TW)

(72) Inventors: PO-HUI LU, New Taipei (TW); CHUN-NAN YU, New Taipei (TW); SHU-LING LU, New Taipei (TW)

(21) Appl. No.: 13/928,804

(22) Filed: Jun. 27, 2013

(30) Foreign Application Priority Data
Jul. 19, 2012 (TW) 101125962

(51) Int. Cl. H04N 5/232

(52) U.S. Cl. CPC H04N 5/23206
USPC 348/207.11

(57) ABSTRACT

In an IP camera control method, a web server transmits a show page, on which a control panel is displayed, to an electronic terminal, and then an IP camera is controlled according to a touch operation on the control panel of the electronic terminal.

### BACKGROUND

1. Technical Field

Embodiments of the present disclosure are related to network communication technology, and more particularly to a system and a method for controlling IP cameras.

2. Description of Related Art

Internet protocol (IP) camera, also called a network camera, can be described as a camera and a computer combined in one network node. During the display of images generated by an IP camera on an electronic terminal such as a personal computer or a smart phone, which communicates with the IP camera through a network, the camera may need to be rotated or the zoom may need to be adjusted in or out. Thus, software that controls rotation and zooming in/out of the IP camera, for different operation systems, such as ANDROID, IOS, WINDOWS, needs to be designed. In addition, the software must be installed by the user. Thus, it is inconvenient for software designers and the users.

### BRIEF DESCRIPTION OF THE DRAWINGS

FIG. 1 is a block diagram of one embodiment of a network framework including a plurality of IP cameras.

FIG. 2 is a block diagram of one embodiment of a web server including an IP camera control system.

FIG. 3 is a block diagram of one embodiment of function modules of the IP camera control system.

FIG. 4 illustrates a flowchart of one embodiment of an IP camera control method.

FIG. 5 illustrates a schematic diagram of a control panel of the terminal device.

### DETAILED DESCRIPTION

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

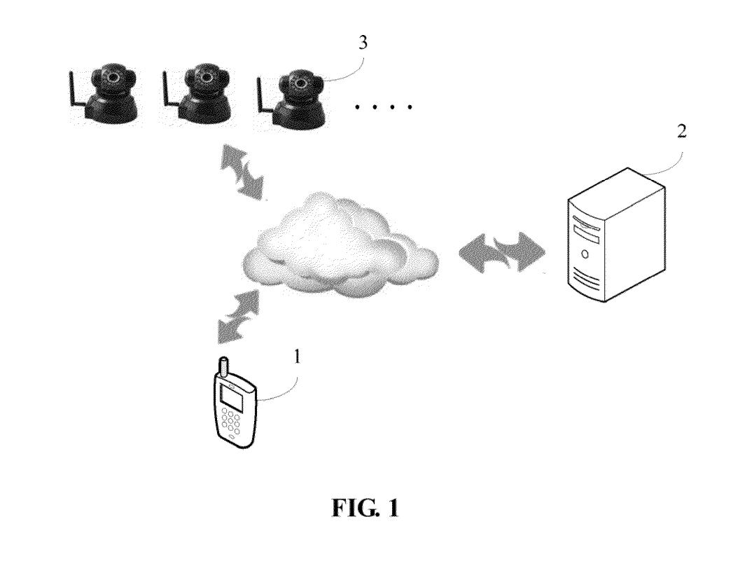

FIG. 1 is a block diagram of one embodiment of a network framework including a plurality of an IP cameras 3. In one embodiment, the network framework further includes an electronic terminal 1 and a web server 2. The electronic terminal 1, the web server 2, and the plurality of IP cameras 3 communicate with each other by the Internet or an intranet. The electronic terminal 1 may be a smart phone, a tablet personal computer, a personal digital assistant (PDA), for example.

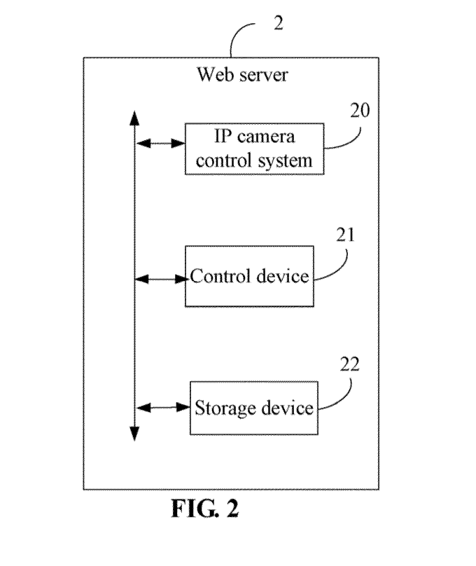

FIG. 2 is a block diagram of one embodiment of the web server 2. The web server 2 includes an IP camera control system 20. In one embodiment, the web server 2 further includes, but not be limited to, a control device 21 and a storage device 22.

The control device 21 may include a processor, an application-specific integrated circuit (ASIC), and a field programmable gate array (FPGA), for example.

The storage device 22 may include any type(s) of non-transitory computer-readable storage medium, such as a hard disk drive, a compact disc, a digital video disc, or a tape drive.

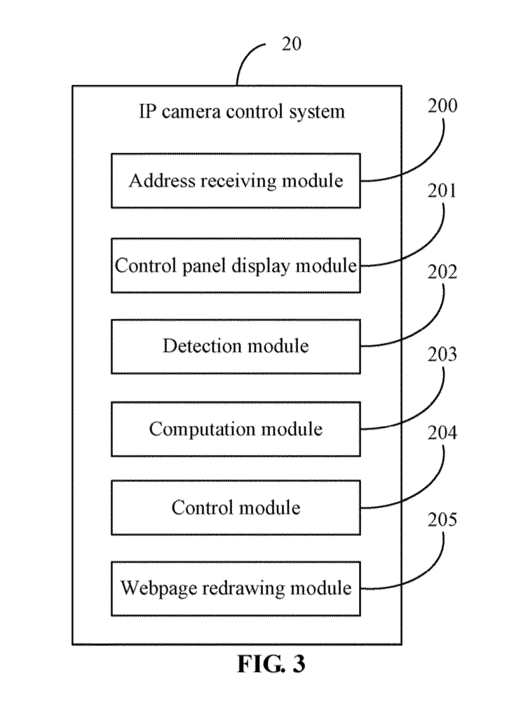

The IP camera control system 20 includes a plurality of function modules (see FIG. 3), which include computerized code stored in the storage device 22, and when executed by the control device 21, to control the plurality of IP cameras 3 to rotate or zoom in/out.

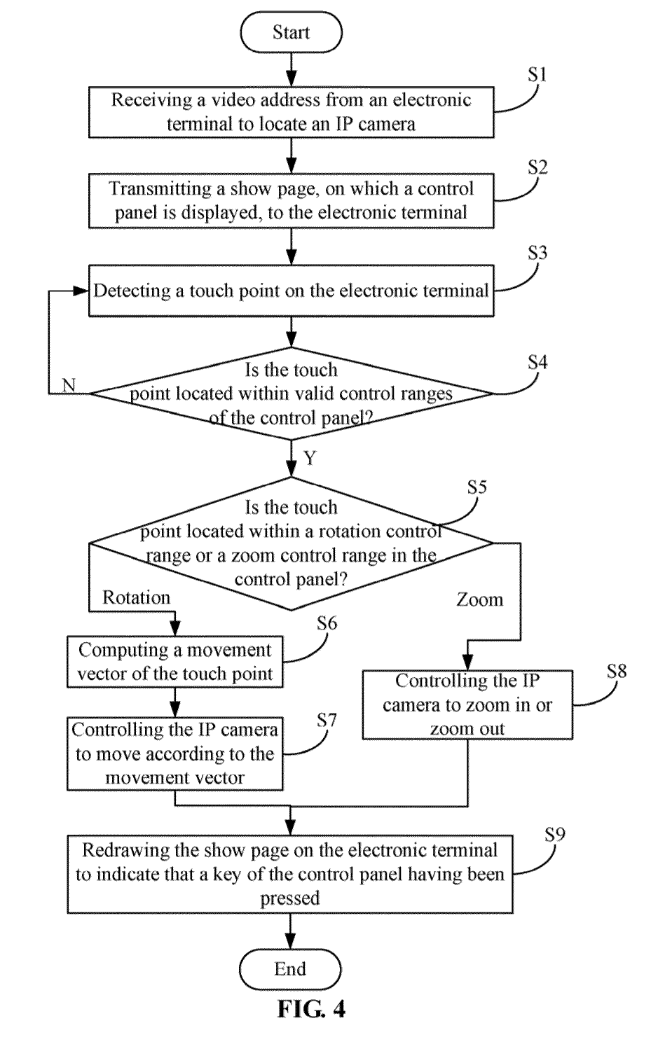

FIG. 3 is a block diagram of one embodiment of the function modules of the IP camera control system 20. In one embodiment, the plurality of function modules may include an address receiving module 200, a control panel display module 201, a detection module 202, a computation module 203, a control module 204, and a webpage redrawing module 205. The detailed functions of the function modules 200-205 are illustrated in FIG. 4 below.

FIG. 4 illustrates a flowchart of one embodiment of an IP camera control method. In the embodiment, the method controls one or more IP cameras 3 using the terminal device 1 and the web server 2. Depending on the embodiment, additional steps may be added, others removed, and the ordering of the steps may be changed.

In step S1, the address receiving module 200 receives a video address from the electronic terminal 1, to locate one of the IP cameras 3. In one embodiment, the video address includes an IP address of one of the IP cameras 3, a user name of the electronic terminal 1, and an identifier of controlling the IP cameras 3. For example, the IP address of the IP camera 3 is “10.62.8.119,” the user name of the electronic terminal 1 is “firstIPcamera” and the identifier of controlling the IP camera 3 is “controlPTZ”, then the video address is http://10.62.8.119/firstIPcamera/controlPTZ.

In one embodiment, a user of the electronic terminal 1 inputs the video address via a browser of the electronic terminal 1. The browser may be an INTERNET EXPLORER browser, a FIREFOX browser, or a GOOGLE browser, for example. The electronic terminal 1 then transmits the video address to the web server 2 using the Internet or an intranet.

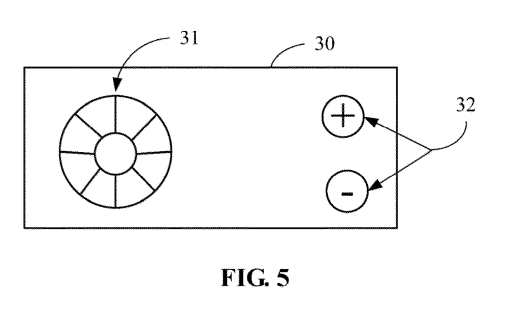

In step S2, the control panel display module 201 transmits a show page, on which a control panel is displayed, to the electronic terminal 1. FIG. 5 illustrates a schematic diagram of a control panel 30. In one embodiment, the control panel 30 includes two control ranges, one of which is a rotation control range 31 and the other one of which is a zoom control range 32. The rotation control range 31 includes eight rotation keys, respectively, a leftward rotation key, a rightward rotation key, an upward rotation key, a downward rotation key, a top-leftward rotation key, a top-rightward rotation key, a bottom-leftward rotation key, and a bottom-rightward rotation key. The zoom control range 32 includes a zoom-in key and a zoom-out key.

In step S3, the detection module 202 detects a touch point of a touch operation to the control panel on the electronic terminal 1. The touch operation may be generated by a user touching the electronic terminal 1 using his finger or a stylus, for example. In other embodiment, the touch operation may be generated by a mouse of electronic terminal 1.

In step S4, the detection module 202 determines if the touch point is located within valid control ranges of the control panel. The valid control ranges include the rotation control range 31 and the zoom control range 32. The detection module 202 compares coordinates of the touch point and a coordinate range of the rotation control range 31 and the zoom control range 32 to determine if the touch point is located within the valid control ranges of the control panel 30. When the touch point is located within the valid control ranges of the control panel 30, step S5 is implemented. Otherwise, when the touch point is not located within the valid control ranges of the control panel 30, the touch point is invalid, then, step S3 is implemented.

In step S5, the detection module 202 determines that the touch point is located within the rotation control range 31 or located within the zoom control range 32. Steps S6 and S7 are implemented when the touch point is located within the rotation control range 31. Otherwise, step S8 is implemented when the touch point is located within the zoom control range 32.

In step S6, the computation module 202 computes a movement vector of the touch point according to a movement track of the touch point on the electronic terminal 1. The movement vector includes a direction, a distance, and a speed of the movement track of the touch point.

In step S7, the control module 204 controls the IP camera 3 to rotate according to the movement vector. For example, when the direction of the movement track of the touch point is left, the speed is 1 cm/s, and the distance is 2 cm, the IP camera is controlled to rotate left 2 cm, at the speed of 1 cm/s. In other embodiment, the IP camera 3 is controlled to rotate according to a rate of the movement vector. For example, when the direction of the movement track of the touch point is left, the speed is 1 cm/s, and the distance is 2 cm, then the IP camera rotates left 20 cm, at the speed of 10 cm/s.

In step S8, the control module 204 control the IP camera 3 to zoom in or zoom out. When the touch point is located within the range of the zoom-in key, the IP camera 3 zooms in, and when the touch point is located within the range of the zoom-out key, the IP camera 3 zoom out.

In step S9, the webpage redrawing module 205 redraws the show page on the electronic terminal 1 to indicate that a key in the control panel having been pressed. For example, when the IP camera is controlled to rotate to left, the show page of the electronic terminal 1 is redrawn to show the leftward rotation key of the control panel has been pressed.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. An IP camera control method being performed by execution of computerized codes by at least one processor of a web server, the method comprising:
transmitting a show page, on which a control panel is displayed, to an electronic terminal; and
controlling an IP camera according to a touch operation on the control panel of the electronic terminal.

2. The method according to claim 1, wherein before transmitting of the show page, the method further comprises:
receiving a video address from the electronic terminal to locate the IP camera, wherein the video address comprises an IP address of the IP camera, a user name of the electronic terminal, and an identifier for controlling the IP camera.

3. The method according to claim 1, wherein the control panel comprises a rotation control range and a zoom control range.

4. The method according to claim 3, wherein the rotation control range comprises a leftward rotation key, a rightward rotation key, an upward rotation key, a downward rotation key, a top-leftward rotation key, a top-rightward rotation key, a bottom-leftward rotation key, and a bottom-rightward rotation key, and wherein the zoom control range comprises keys of a zoom-in key and a zoom-out key.

5. The method according to claim 3, wherein the controlling step comprising:
detecting a touch point of the touch operation on the control panel of the electronic terminal; and
computing a movement vector of the touch point according to a movement track of the touch point, and controlling the IP camera to rotate according to the movement vector when the touch point is located within the rotation control range; or
controlling the IP camera to zoom in or zoom out when the touch point is located within the zoom control range.

6. The method according to claim 5, wherein the movement vector comprises a direction, a distance, and a speed of the movement track of the touch point.

7. The method according to claim 3, further comprising:
redrawing the show page on the electronic terminal to indicate that of the keys in the control panel having been pressed.

8. A web server, comprising:
a control device;
a storage device storing one or more programs which when executed by the control device, causes the control device to:
transmit a show page, on which a control panel is displayed, to an electronic terminal; and
control an IP camera according to a touch operation on the control panel of the electronic terminal.

9. The web server according to claim 8, wherein before transmitting the show page, the control device further:
receive a video address from the electronic terminal to locate the IP camera, wherein the video address comprises an IP address of the IP camera, a user name of the electronic terminal, and an identifier for controlling the IP camera.

10. The web server according to claim 8, wherein the control panel comprises a rotation control range and a zoom control range.

11. The web server according to claim 10, wherein the rotation control range comprises a leftward rotation key, a rightward rotation key, an upward rotation key, a downward rotation key, a top-leftward rotation key, a top-rightward rotation key, a bottom-leftward rotation key, and a bottom-rightward rotation key, wherein the zoom control range comprises keys of a zoom-in key and a zoom-out key.

12. The web server according to claim 10, wherein the controlling step comprising:
detecting a touch point of the touch operation on the control panel of the electronic terminal; and
computing a movement vector of the touch point according to a movement track of the touch point, and controlling the IP camera to rotate according to the movement vector when the touch point is located within the rotation control range; or
controlling the IP camera to zoom in or zoom out when the touch point is located within the zoom control range.

13. The web server according to claim 12, wherein the movement vector comprises a direction, a distance, and a speed of the movement track of the touch point.

14. The web server according to claim 10, wherein the control device is further to:
redraw the show page on the electronic terminal to indicate that one of the keys in the control panel having been pressed.

15. A non-transitory storage medium having stored thereon instructions that, when executed by a processor of a web server, causes the processor to perform an IP camera control method, the method comprising:
transmitting a show page, on which a control panel is displayed, to an electronic terminal; and
controlling an IP camera according to a touch operation on the control panel of the electronic terminal.

16. The storage medium according to claim 15, wherein before transmitting a show page the method further comprises:
receiving a video address from the electronic terminal to locate the IP camera, wherein the video address comprises an IP address of the IP camera, a user name of the electronic terminal, and an identifier for controlling the IP camera.

17. The storage medium according to claim 15, wherein the control panel comprises a rotation control range and a zoom control range.

18. The storage medium according to claim 17, wherein the controlling step comprises:
detecting a touch point of the touch operation on the control panel of the electronic terminal; and
computing a movement vector of the touch point according to a movement track of the touch point, and controlling the IP camera to rotate according to the movement vector when the touch point is located within the rotation control range; or
controlling the IP camera to zoom in or zoom out when the touch point is located within the zoom control range.

19. The storage medium according to claim 18, wherein the movement vector comprises a direction, a distance, and a speed of the movement track of the touch point.

20. The storage medium according to claim 17, wherein the method further comprises:
redrawing the show page on the electronic terminal to indicate that one of the keys in the control panel having been pressed.
